(19) United States
(12) Patent Application Publication
(10) Pub. No.: US 2021/0231311 A1
(43) Pub. Date: Jul. 29, 2021

(54) COOKING APPARATUS AND METHOD FOR CONTROLLING THEREOF

(71) Applicant: Samsung Electronics Co., Ltd., Suwon-si (KR)

(72) Inventors: Sanggyun YE, Suwon-si (KR); Seunggee HONG, Suwon-si (KR)

(21) Appl. No.: 17/157,908

(22) Filed: Jan. 25, 2021

(30) Foreign Application Priority Data
Jan. 23, 2020 (KR) 10-2020-0009286

(51) Int. Cl. F24C 7/08; F24C 15/16

(52) U.S. Cl. CPC F24C 7/085; F24C 15/16; F24C 7/087

(57) ABSTRACT

A cooking apparatus may include a display; an input configured to receive an user's input; a shelf disposed inside a cooking chamber of the cooking apparatus, the shelf including a first cooking area and a second cooking area; a heater configured to provide heat to at least one of the first cooking area and the second cooking area; and a controller. The controller may be configured to determine at least one cooking area in which cooking is to be performed among the first cooking area or the second cooking area based on the user's input; control the display to display a recipe related to the determined cooking area; and control the heater in response to a selection of the recipe.

### CROSS-REFERENCE TO RELATED APPLICATION

This application is based on and claims priority under 35 U.S.C. § 119 to Korean Patent Application No. 10-2020-0009286 filed on Jan. 23, 2020 in the Korean Intellectual Property Office, the disclosure of which is incorporated by reference herein in its entirety.

### BACKGROUND

### 1. Field

Embodiments of the disclosure relate to a cooking apparatus and a method for controlling thereof.

### 2. Description of the Related Art

A cooking apparatus is an apparatus for cooking by heating a cooking object such as food, and means an apparatus capable of providing various functions related to cooking, such as heating, defrosting, drying, and sterilization of the cooking object. Examples of such a cooking apparatus include, for example, an oven such as a gas oven or an electric oven, a microwave heating device (hereinafter, referred to as a microwave oven, microwave), a gas stove, an electric stove, a gas grill, or an electric grill.

In general, an oven is a device that cooks food by directly transferring heat to food through a heat source that generates heat such as a heater or by heating the inside of a cooking chamber, and a microwave oven is a device that cooks food by frictional heat between molecules generated by disturbing the molecular arrangement of food by using a high frequency as a heat source.

Recently, a cooking apparatus including both a heater and a magnetron has appeared, and a cooking apparatus capable of simultaneously cooking a plurality of dishes has also appeared.

### SUMMARY

One aspect provides a cooking apparatus and a method for controlling thereof that determining the dishes to be cooked at the same time and the cooking area in which each dish is placed according to the user's intention.

In accordance with an aspect of the disclosure, a cooking apparatus may comprise a display; an input configured to receive an user input; a shelf disposed inside a cooking chamber, and including a first cooking area and a second cooking area; a heater configured to provide heat to at least one of the first cooking area and the second cooking area; and a controller configured to determine at least one cooking area in which cooking is to be performed among the first cooking area or the second cooking area based on the user's input, control the display to display a recipe related to the determined cooking area, and control the heater in response to the selection of the recipe.

The controller may be configured to control the display to display a list of second sub recipes applicable to the second cooking area when the first cooking area is selected by the user's input and a first sub recipe related to the first cooking area is selected.

The controller may be configured to control a first heater that provides heat to the first cooking area based on the first sub recipe, and controls a second heater that provides heat to the second cooking area based on the second sub recipe when the second sub recipe applied to the second cooking area is determined.

The controller may be configured to control the display to display a main recipe including a first sub recipe and a second sub recipe when both the first cooking area and the second cooking area are selected within a predetermined time by the user's input.

The controller may be configured to apply one of the first sub recipe or the second sub recipe to the first cooking area and the other to the second cooking area based on the user's input.

The controller may be configured to control the display an inquiry message regarding an application location of each of the first sub recipe and the second sub recipe.

The cooking apparatus may further include a sensor configured to identify the food disposed on the shelf, and the controller may be configured to control the heater to provide heat to the determined cooking area when the food is located in the determined cooking area.

The controller may be configured to control the display to display a warning message guiding a change of the location of the food when the food is not located within the determined cooking area.

In accordance with another aspect of the disclosure, a controlling method of a cooking apparatus may include determining at least one cooking area in which cooking is to be performed among a first cooking area or a second cooking area disposed inside a cooking chamber based on an user's input received through an input, controlling a display to display a recipe related to the determined cooking area, and controlling the heater in response to the selection of the recipe.

The controlling the display may include controlling the display to display a list of second sub recipes applicable to the second cooking area when the first cooking area is selected by the user's input and a first sub recipe related to the first cooking area is selected.

The controlling the display may include controlling a first heater that provides heat to the first cooking area based on the first sub recipe, and controls a second heater that provides heat to the second cooking area based on the second sub recipe when the second sub recipe applied to the second cooking area is determined.

The controlling the display may include controlling the display to display a main recipe including a first sub recipe and a second sub recipe when both the first cooking area and the second cooking area are selected within a predetermined time by the user's input.

The method further includes applying one of the first sub recipe or the second sub recipe to the first cooking area and the other to the second cooking area based on the user's input.

The controlling the display may include controlling the display an inquiry message regarding an application location of each of the first sub recipe and the second sub recipe.

The method may further include identifying a food disposed on the shelf by a sensor, and controlling the heater may include controlling the heater to provide heat to the determined cooking area when the food is located in the determined cooking area.

The controlling the display further may include displaying a warning message guiding a change of the location of the food when the food is not located within the determined cooking area.

According to the above disclosure, the disclosed cooking apparatus may determine a cooking area in which the food is disposed and a recipe to be applied to the cooking area according to a user's intention when cooking a plurality of foods simultaneously.

That is, according to the disclosed cooking apparatus and its control method, a user can designate a cooking area in which food is placed, and select a recipe to be applied to the designated cooking area. Therefore, user convenience can be improved.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a perspective view of a cooking apparatus according to an embodiment;

FIG. 2 illustrates a partial configuration of the interior of a cooking apparatus according to an embodiment;

FIG. 3 illustrates a cross-sectional diagram of a cooking apparatus according to an embodiment;

FIG. 4 illustrates a heat source and a shelf of a cooking apparatus according to an embodiment;

FIG. 5 illustrates a top plan view of a cooking apparatus according to an embodiment;

FIG. 6 illustrates that the heater and the electric wire of the cooking apparatus according to an embodiment are combined;

FIG. 7 illustrates a control block diagram of a cooking apparatus according to an embodiment; and

FIGS. 8, 9, 10, and 11 are flowcharts illustrating a method of controlling a cooking apparatus.

### DETAILED DESCRIPTION

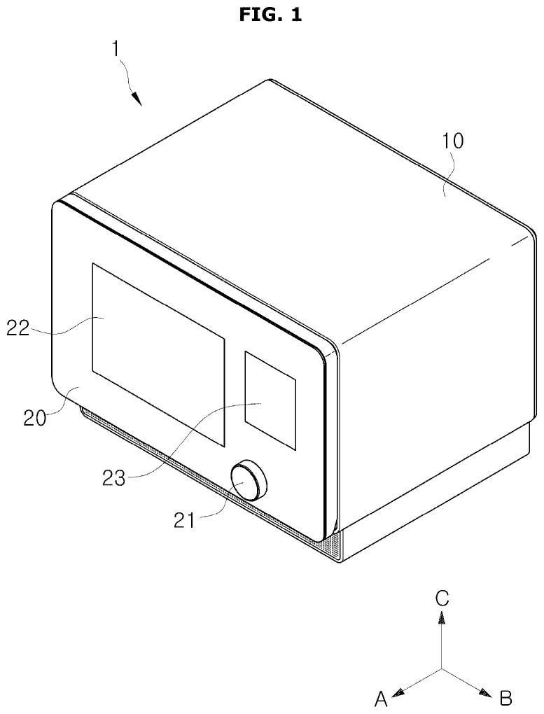

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Configurations shown in the embodiments and drawings described herein are only exemplary embodiments of the disclosed invention, there may be various modifications that can replace the embodiments and drawings of the present specification at the time of filing of the present application.

In addition, the same reference numerals or signs in each of the drawings of the present specification represent parts or components that perform substantially the same function.

Also, the terminology used herein is for the purpose of describing particular embodiments only and is not intended to be limiting and/or restricting the disclosed invention. Singular expressions include plural expressions unless the context clearly indicates otherwise. In this specification, the terms “comprise” or “have” are intended to indicate that there is a feature, number, step, action, component, part, or combination thereof described in the specification, and one or more other features. It does not exclude in advance the possibility of the presence or the addition of numbers, steps, operations, components, parts or combinations thereof.

In addition, terms including ordinal numbers such as “first” and “second” as used herein may be used to describe various components, but the components are not limited by the terms. It is used only to distinguish one component from another. For example, without departing from the scope of the present invention, the first component may be referred to as the second component, and similarly, the second component may also be referred to as the first component. The term “and/or” includes any combination of a plurality of related items or any of a plurality of related items.

Terms such as “˜unit”, “˜group”, “˜block”, “˜member”, and “˜module” used in the specification may be implemented in software or hardware. Terms such as “˜unit”, “˜group”, “˜block”, “˜member”, and “˜module” may mean a unit that processes at least one function or operation. In addition, terms such as “˜unit”, “˜group”, “˜block”, “˜member”, and “˜module” are used in at least one piece of hardware, circuit, or at least one software or processor stored in a memory.

Throughout the specification, when a part is said to be “connected” with another part, this includes not only the case of being directly connected but also the case of being indirectly connected, and an indirect connection involves connecting through a wireless communication network.

In each step, the identification code is used for convenience of explanation, and the identification code does not describe the order of each step, and each step may be implemented differently from the specified order unless a specific order is clearly stated in the context.

Hereinafter, embodiments of the disclosure will be described in detail with reference to the accompanying drawings.

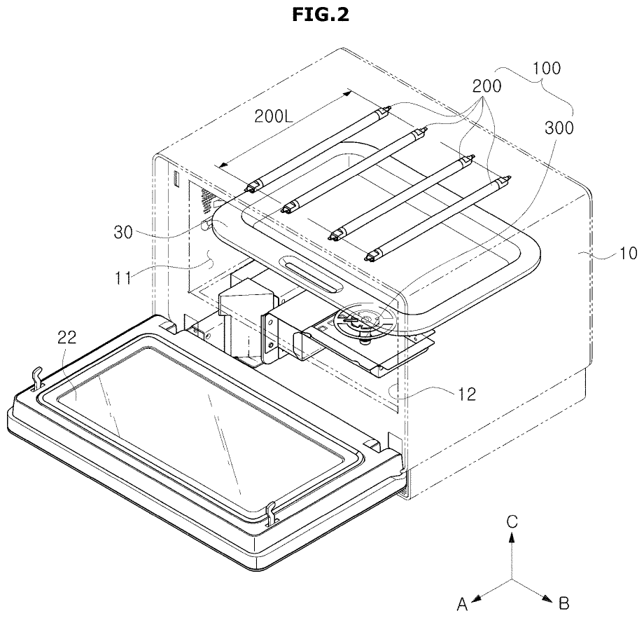

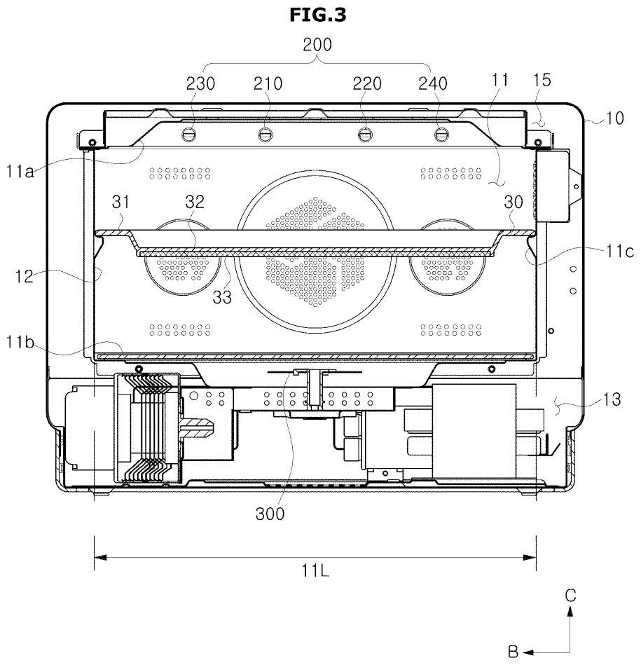

FIG. 1 illustrates a perspective view of a cooking apparatus according to an embodiment. FIG. 2 illustrates a partial configuration of the interior of a cooking apparatus according to an embodiment. FIG. 3 illustrates a cross-sectional diagram of a cooking apparatus according to an embodiment.

Referring to FIG. 1, the cooking apparatus 1 may include a housing 10 forming an exterior, and a door 20 provided to open and close openings of the housing 10 and the inner housing 12.

An input 21 for acquiring a user's input related to the operation of the cooking apparatus 1 may be provided in the door 20. The input 21 is not provided on the door 20 but may be provided at another location of the cooking apparatus 1. Input 21 may output an electrical signal (voltage or current) corresponding to a user input to the controller 600. In FIG. 1, input 21 is illustrated in the form of a jog dial, but is not limited thereto. For example, input 21 may be provided in the form of a button.

In addition, a transparent member 22 may be provided on the door 20. The user can observe the inside of the cooking chamber 11 through the transparent member 22 when the door 20 is closed.

In addition, a display 23 for displaying information related to the operation of the cooking apparatus 1 may be provided on the door 20. The display 23 may not be provided on the door 20 but may be provided at another location of the cooking apparatus 1. The display 23 may include various types of display panels. For example, the display 23 may be a Liquid Crystal Display Panel (LCD Panel) or a Light Emitting Diode Panel (LED Panel), or an Organic Light Emitting Diode Panel (OLED Panel), or a micro LED panel. The display 23 may also be used as an input device including a touch panel.

The display 23 may display information input by the user or information provided to the user on various screens. In addition, the display 23 may display a graphic user interface (GUI) that enables control of the cooking apparatus 1. That is, the display 23 may display a user interface element (UI) such as an icon.

Referring to FIGS. 2 and 3, the cooking apparatus 1 may include a cooking chamber 11 provided inside the housing 10 and in which food may be placed. In addition, the cooking apparatus 1 may include an inner housing 12 disposed inside the housing 10 and forming the cooking chamber 11. A predetermined space 15 may be formed between the inner housing 12 and the housing 10.

The housing 10 and the inner housing 12 may be provided to be opened in a first direction A, which is a front direction of the cooking apparatus 1. The user may place the food in the cooking chamber 11 through the opening of the inner housing 12 formed in the first direction A. The cooking chamber 11 may be provided in a rectangular parallelepiped shape having a long side 11L in a second direction B orthogonal to the first direction A in a left-right direction.

The cooking apparatus 1 may include a machine room 13 formed in the housing 10 and disposed below the cooking chamber 11. Various electric parts for operating the cooking apparatus 1 may be disposed inside the machine room 13.

The cooking apparatus 1 may include a shelf 30 mounted inside the cooking chamber 11 and on which food is placed. The shelf 30 may be disposed to be detachable inside the cooking chamber 11. The cooking chamber 11 may include support portions 11c formed on both sides of the cooking chamber 11 so that the shelf 30 is mounted between the upper surface 11a and the lower surface 11b of the cooking chamber 11.

A plurality of support portions 11c may be provided in the third direction C so that the shelf 30 is mounted at various heights. The third direction C is a direction perpendicular to the first direction A or the second direction B.

The shelf 30 may include a main body 31 and a cooking surface 32 on which food can be placed. The cooking surface 32 may be provided to face the upper surface 11a of the cooking chamber 11 when the shelf 30 is mounted. The cooking surface 32 may have a rectangular shape having a long side in the second direction B and a short side in the first direction A.

The cooking apparatus 1 may include a heat source 100 that provides heat to the inside of the cooking chamber 11 so that the food is cooked by heat. The heat source 100 may provide heat to the food placed on the shelf 30. In addition, the food may be located on the lower surface 11b of the cooking chamber 11 without the shelf 30. The heat source 100 may also provide heat to the food located on the lower surface 11b.

The heat source 100 may include a heater 200 disposed on the upper surface 11a of the cooking chamber 11. The heater 200 may be provided in a plurality (210, 220, 230, 240). Heat generated by the plurality of heaters 210, 220, 230, 240 is transferred to the food. The heater 200 may be defined as a first heat source.

In addition, the heat source 100 may include a magnetron 300 disposed on the lower surface 11b of the cooking chamber 11. The magnetron 300 may be defined as a second heat source. The magnetron 300 may generate a high frequency. The high frequency generated by the magnetron 300 repeatedly converts the molecular arrangement of moisture contained in the food, and the food may be heated by frictional heat between the moisture molecules. The magnetron 300 may be disposed in the machine room 13. The magnetron 300 may oscillate a high frequency from the machine room 13 toward the lower surface 11b of the cooking chamber 11, and the high frequency may pass through the lower surface 11b and be irradiated to the shelf 30.

In the conventional microwave-type cooking apparatus, food is heated using a single magnetron. However, according to the moisture distribution or moisture content of the food, there was a problem that high frequency could not be transmitted evenly to the whole food, and there was a problem that the food could not be cooked efficiently. To solve this problem, a heater that can transfer heat to the whole food may be installed in the cooking apparatus. By providing food with additional heat, cooking can proceed efficiently.

The cooking apparatus 1 according to an exemplary embodiment may include the heater 200 and the magnetron 300 to efficiently cook food. As described above, the heater 200 is disposed on the upper surface 11a of the cooking chamber 11 to transfer heat to the upper portion of the food. However, the heater 200 may not efficiently transfer heat to the lower portion of the food.

The cooking apparatus 1 according to an embodiment may provide a heating unit 33 on the shelf 30 so that heat is efficiently transferred to the lower portion of the food. The heating unit 33 may be disposed on the opposite side of the cooking surface 32 in the main body 31 of the shelf 30. The heating unit 33 may be provided to face the lower surface 11b of the cooking chamber 11 when the shelf 30 is mounted on the cooking chamber 11.

The heating unit 33 may absorb high frequency generated from the magnetron 300 and generate heat. Heat generated by the heating unit 33 may be transferred to the cooking surface 32 through the main body 31 of the shelf 30. That is, heat generated by the heating unit 33 is conducted to the cooking surface 32, so that heat may be supplied to the lower portion of the food located on the cooking surface 32. The heating unit 33 may be formed of a ferrite material to absorb high frequency. However, the present invention is not limited thereto, and a material capable of generating heat by high frequency may be mixed with ceramic or the like to form the heating unit 33.

Accordingly, even if the user does not turn the food over in the middle of the cooking process, heat can be supplied in the vertical direction of the food, so that cooking can be conducted efficiently.

The cooking apparatus 1 according to an embodiment may include a cooking chamber 11 having a rectangular parallelepiped shape that is formed to be long in the second direction B and relatively short in the first direction A. In other words, the cooking chamber 11 may have a rectangular parallelepiped shape having a long side 11L in the second direction B.

On the other hand, there is a case where a plurality of foods having different cooking temperatures are simultaneously placed in the cooking chamber 11 and cooked. In this case, the cooking apparatus 1 may set different temperatures of heat generated from the plurality of heaters 200 (210, 220, 230, 240). Therefore, it is possible to transfer different heat energy to multiple foods.

When a plurality of heaters 210, 220, 230, 240 according to an embodiment are disposed on the upper surface 11a of the cooking chamber 11, the plurality of food items may be disposed at positions corresponding to the positions of the plurality of heaters 210, 220, 230, and 240. For example, the cooking surface 32 of the shelf 30 may be divided into a plurality of cooking regions, and the plurality of cooking regions may be heated to different temperatures. The plurality of food items may be located in each of the plurality of cooking areas. Thus, different heat energy can be provided to each of the plurality of foods.

A plurality of cooking regions provided at positions corresponding to each of the plurality of heaters 210, 220, 230, and 240 in the third direction C may be formed on the cooking surface 32. Each cooking region may be provided so that different heat generated from each heater is directly transmitted.

Accordingly, even if a plurality of foods having different cooking temperatures are simultaneously placed in the cooking chamber, each food may be cooked according to different cooking temperatures. That is, when each food is placed in a different cooking area, each food can be cooked at a different temperature.

However, in a conventional cooking apparatus, since heaters having a length in the second direction B are spaced apart in the first direction A, a plurality of cooking areas capable of receiving different temperatures are provided in the first direction A. When a plurality of cooking areas are partitioned in the first direction A, which is the direction of the short side 32S of the cooking surface 32, the plurality of cooking areas have a short width. Since the width of each of the plurality of cooking areas formed in the first direction A is short, the temperature difference between the substantially divided cooking areas may be small. In addition, in the same structure as a conventional cooking apparatus, when a bulky food is input, the food may be out of one area of the cooking surface 32 and thus a problem may occur in that the food cannot be cooked at an appropriate temperature. In addition, since the conventional cooking apparatus divides a plurality of cooking areas in the first direction A, among the plural foods, food that is placed deeply in the rear of the cooking chamber causes discomfort that cannot be easily observed.

In order to solve such a problem, the cooking apparatus 1 according to an embodiment includes a plurality of heaters 200: 210, 220, 230, 240 having a long axis 200L extending in the first direction A. Each of the heaters 200 (210, 220, 230, 240) may be spaced apart in the second direction B corresponding to the long side 11L of the cooking chamber 11.

Accordingly, on the cooking surface 32 of the shelf 30, a plurality of cooking areas 34 and 35 receiving heat of different temperatures may be divided along the second direction B. Hereinafter, a plurality of heaters 200 (210, 220, 230, 240) according to an embodiment and a plurality of cooking areas 34 and 35 partitioned on the shelf 30 will be described in detail.

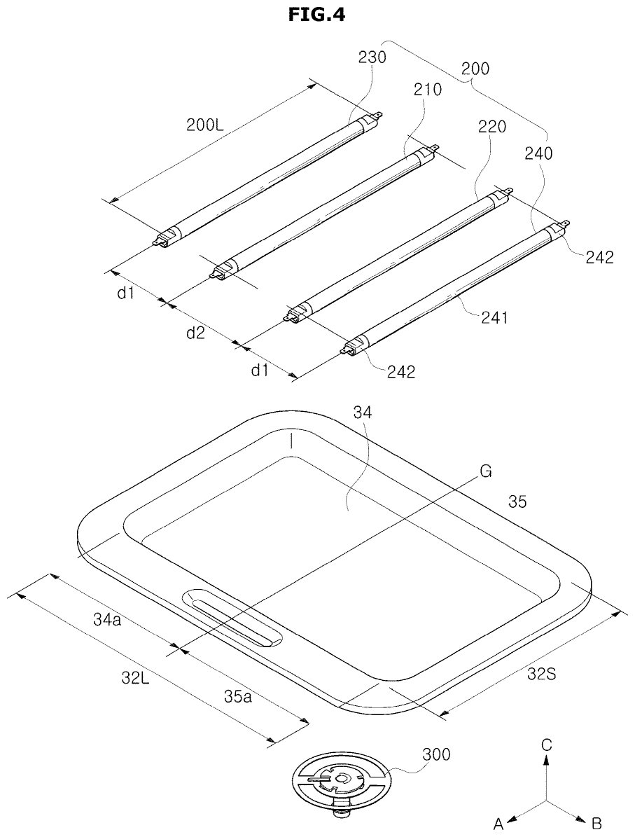

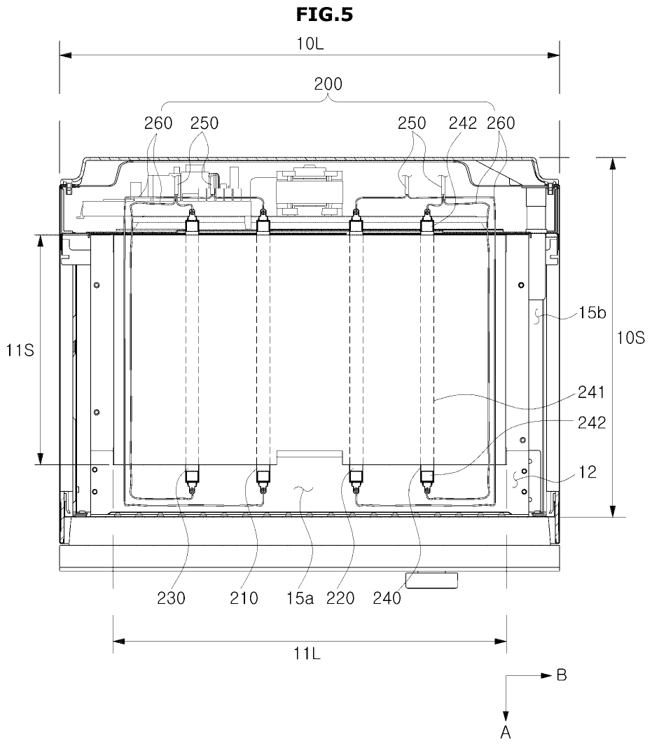

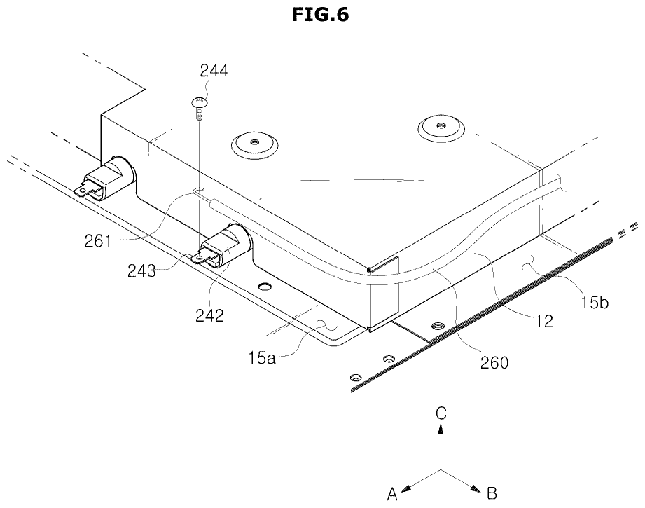

FIG. 4 illustrates a heat source and a shelf of a cooking apparatus according to an embodiment. FIG. 5 illustrates a top plan view of a cooking apparatus according to an embodiment. FIG. 6 illustrates that the heater and the electric wire of the cooking apparatus according to an embodiment are combined.

Referring to FIGS. 4 and 5, each of a plurality of heaters 200: 210, 220, 230, and 240 has a long axis 200L extending in the first direction A, and a plurality of heaters 200: 210, 220 , 230, 240 may be spaced apart from each other in the second direction B corresponding to the long side 11L of the cooking chamber 11. The separation distance between the plurality of heaters 200: 210, 220, 230, and 240 may be a first separation distance d1 and/or a second separation distance d2.

The first heater 210 and the third heater 230 are arranged to have a first separation distance d1 on the first cooking area 34, and the second heater 220 and the fourth heater 240 may be arranged to have a first separation distance d1 on the cooking area 35. The first heater 210 and the second heater 220 may be disposed to have a second separation distance d2. The second separation distance d2 may be formed longer than the first separation distance d1. This is to provide a temperature difference between the first cooking area 34 and the second cooking area 35.

The heater 200 has been described as including the first heater 210, the second heater 220, the third heater 230, and the fourth heater 240, but is not limited thereto. The heater 200 may be composed of a first heater 210 and a second heater 220, or may be composed of four or more.

The plurality of heaters 200 (210, 220, 230, 240) all have the same shape, and the description will be made with reference to the fourth heater 240 hereinafter. The fourth heater 240 may include a body portion 241 that extends in a direction of the long axis 200L and generates heat by power, and both ends 242 disposed at both ends of the body portion 241.

Both ends 242 may be provided so that external power is supplied to the fourth heater 240. The body portion 241 may be heated by power supplied from both ends 242, and heat may be transferred to the shelf 30. Both ends 242 may be disposed along the first direction A.

The first heater 210 is disposed on one side of the cooking apparatus 1 in the second direction B, and the second heater 220 is on the opposite side of the first heater 210 in the second direction B. Specifically, the first heater 210 may be disposed on one side and the second heater 220 may be disposed on the opposite side based on the center line G of the cooking surface 32. The third heater 230 may be disposed adjacent to the first heater 210, and the fourth heater 240 may be disposed adjacent to the second heater 220.

Meanwhile, the first heater 210 and the third heater 230 may generate heat of the same temperature. In addition, the second heater 220 and the fourth heater 240 may generate heat of the same temperature. The first and third heaters 210 and 230 and the second and fourth heaters 220 and 240 may generate heat of different temperatures. That is, based on the center line G, the heating temperature of one side and the heating temperature of the opposite side may be different from each other.

For example, the cooking apparatus 1 may set the heating temperature of the first heater 210 to be higher than the heating temperature of the second heater 220. In this case, the first heater 210 and the second heater 220 may be independently controlled based on the set temperature. The first heater 210, the second heater 220, the third heater 230, and the fourth heater 240 may be independently and/or selectively controlled.

Meanwhile, the heating temperature of each of the plurality of heaters 200 (210, 220, 230, 240) is set to be the same, but the driving method of each heater may be controlled differently. For example, during the entire cooking time, the cooking apparatus 1 continuously drives the first and third heaters 210 and 230, and turns on/off repeatedly the second and fourth heaters 220 and 240. Accordingly, the thermal energy provided by the first and third heaters 210 and 230 may be greater than the thermal energy provided by the second and fourth heaters 220 and 240.

In FIG. 4, the shelf 30 may include a first cooking area 34 and a second cooking area 35 formed on the cooking surface 32. A first cooking area 34 may be formed on one side of the center line G, and a second cooking area 35 may be formed on the opposite side. The cooking area is not limited to two, but may be formed of three or more.

The heater 200 may provide heat to at least one of the first cooking area 34 and the second cooking area 35 of the shelf 30. The first heater 210 and the third heater 230 may be disposed at positions corresponding to the first cooking area 34 in the third direction C. The second heater 220 and the fourth heater 240 may be disposed at a position corresponding to the second cooking area 35 in the third direction C.

As described above, when the heat generated by the first and third heaters 210 and 230 and the second and fourth heaters 220 and 240 is different, thermal energy transferred to the first cooking area 34 and the second cooking area 35 may also be different. That is, heat generated by the first heater 210 and the third heater 230 may be transferred from the upper surface 11a to the first cooking area 34. Heat generated by the second heater 220 and the fourth heater 240 may be transferred from the upper surface 11a to the second cooking area 35.

In addition, heat conducted from the heating unit 33 may be transferred to the first cooking area 34 and the second cooking area 35. The heating unit 33 is heated by high frequency oscillations from the magnetron 300 disposed on the lower surface 1b, and heat generated accordingly may be equally conducted to the first cooking area 34 and the second cooking area 35 through the body 32.

Since the heat generated by the first and third heaters 210 and 230 and the second and fourth heaters 220 and 240 is different, respectively, and the heat transferred to the first cooking area 34 and the second cooking area 35 may be different, foods having different cooking temperatures are disposed in the first cooking area 34 and the second cooking area 35, respectively, so that they can be cooked simultaneously.

In addition, different foods may be located in the left and right directions based on the first direction A, which is the front of the cooking apparatus 1, the user can easily observe the cooking state of foods through the transparent member 22.

As shown in FIG. 4, the short side 32S of the cooking surface 32 is orthogonal to the long side 32L, and may extend in the first direction A. In response to the plurality of heaters 200 (210, 220, 230, 240) being spaced apart in the second direction B, the first cooking area 34 and the second cooking area 35 can be divided in the second direction B. Since the long side 32L of the cooking surface 32 extends in the second direction B, the first cooking area 34 and the second cooking area 35 may have a sufficient length in one direction.

That is, the length of the first cooking area 34 along the second direction B may be defined as the first length 34a, and the length of the second cooking area 35 may be defined as the second length 35a. The first length 34a and the second length 35a may be provided to secure an area sufficient for food to be located in the first cooking area 34 or the second cooking area 35. Accordingly, areas of the first cooking area 34 and the second cooking area 35 may be provided as 34a*32S and 35a*32S, respectively.

Meanwhile, the first length 34a or the second length 35a may be provided with the same length as the short side 32S of the cooking surface 32. In this case, the first cooking area 34 and the second cooking area 35 may be provided in a square shape, and food may be easily located within the first cooking area 34 or the second cooking area 35.

In addition, the first length 34a or the second length 35a may be provided with a length different from the short side 32S of the cooking surface 32. In this case, the first cooking area 34 and the second cooking area 35 may have a rectangular shape. However, even when the first cooking area 34 and the second cooking area 35 are provided in a rectangular shape, the ratio between the horizontal length and the vertical length of each of the first cooking area 34 and the second cooking area 35 is provided within a predetermined ratio range. Accordingly, the first cooking area 34 and the second cooking area 35 may provide larger accommodation space than the conventional cooking apparatus described above in receiving food.

Referring to FIG. 5, the housing 10 may have a long side 10L in a second direction B and a short side 10S in a first direction A corresponding to the area of the cooking chamber 11. The plurality of heaters 200 (210, 220, 230, 240) may have a long axis 200L extending in the first direction A and may be spaced apart in the second direction B.

Accordingly, the body portion 241 of the fourth heater 240 may be disposed inside the inner housing 12 and provided to be positioned inside the cooking chamber 11. Both ends 242 of the fourth heater 240 may pass through the inner housing 12 and may be provided to be disposed in the space 15 formed outside the cooking chamber 11.

Each of the plurality of heaters 200 includes a power supply unit 250 for supplying power to the heater 200 and an electric wire 260 coupled with both ends 242 to electrically connect the plurality of heaters 200. The electric wire 260 may be provided to be coupled to both ends 242 in a space 15 formed between the inner housing 12 and the housing 10.

Taking the fourth heater 240 as an example, both ends 242 of the fourth heater 240 are disposed toward the first direction A. Accordingly, the electric wire 260 and both ends 242 may be coupled within the first separation space 15a formed between the long side 10L of the housing 10 and the long side 11L of the cooking chamber 11.

However, when the wire 260 is inserted into both ends 242 in the first direction A or the second direction B, the electric wire 260 may be excessively bent, and stable coupling may be difficult. To solve this, as shown in FIG. 6, both ends 242 of the fourth heater 240 may be provided to be coupled to the wire 260 in the third direction C.

Therefore, even if the first separation space 15a is narrow, the wire 260 and the fourth heater 240 can be stably coupled. That is, as the wire 260 and both ends 242 are coupled in the third direction C, stress in the first direction A or the second direction B due to bending of the electric wire 260 is minimized, and the electric wire 260 and both ends 242 may be stably coupled.

On the other hand, in the case of a conventional cooking apparatus, there is a difference from the present invention in that the heater is disposed toward the second direction B. That is, the heater of the conventional cooking apparatus is combined with the electric wire in the second spaced space 15b formed between the short side 10S of the housing 10 and the short side 11S of the cooking chamber 11.

The electric wire 260 connected to the heaters 200 according to an embodiment may include a contact portion 261 that is in contact with both ends 242 of each of the heaters 200 to supply power. Both ends 242 may include a flange 243 provided to contact the contact portion 261 in the third direction C. Both ends 242 may include a coupling member 244 provided so that the contact portion 261 is coupled to the flange 243 in a state in which the flange 243 and the contact portion 261 are in contact. The coupling member 244 may be provided with screws or the like. The coupling member 244 is coupled with the flange 243 in the third direction C while the contact portion 261 is in contact with the flange 243 in the third direction C, and then the contact state of the flange 243 and the contact portion 261 may be fixed.

Therefore, because the direction in which the heaters 200 and the wire 260 are assembled is formed to correspond to the third direction C, even if the first separation space 15a is narrow, the heaters 200 and the electric wire 260 can be easily assembled.

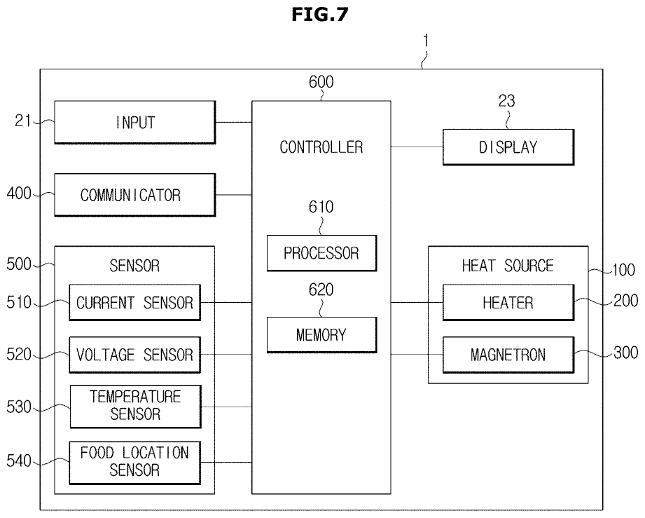

FIG. 7 illustrates a control block diagram of a cooking apparatus according to an embodiment.

Referring to FIG. 7, a cooking apparatus 1 according to an embodiment may include an input 21, a display 23, a heat source 100, a communicator 400, a sensor 500, and a controller 600. The controller 600 is electrically connected to the input 21, the heat source 100, the communicator 400, and the sensor 500.

The input 21 can obtain user input. The input 21 may receive a command related to the operation of the cooking apparatus 1 from the user. For example, the input 21 may receive one or more of a command for selecting a cooking area, a command for selecting a recipe, a command for adjusting the output of a heat source, or a command for adjusting a cooking time from the user. The processor 610 may process a user's input acquired by input 21 and control an operation of the cooking apparatus 1 corresponding to the user's input. The cooking apparatus 1 may automatically perform cooking according to a recipe obtained from a server (not shown) or a memory 620.

As described above, the heat source 100 may include a heater 200 and a magnetron 300. The heater 200 may be provided in a plurality (210, 220, 230, 240). The heater 200 may be defined as a first heat source, and the magnetron 300 may be defined as a second heat source.

The communicator 400 may transmit and receive data with a server (not shown). Specifically, the communicator 400 may receive recipe data from a server (not shown) under the control of the controller 600. The communicator 400 connects the cooking apparatus 1 to an external device or a server through a network or a communication channel. The communicator 400 may include various communication modules. For example, the communicator 400 may include carious communication module connectable to various communication networks such as Bluetooth, Zigbee, wireless local area network (wireless local area network), home radio frequency (RF), ultra-wide band (UWB), and the Internet.

The sensor 500 may include one or more of a current sensor 510, a voltage sensor 520, and a temperature sensor 530. The current sensor 510 may measure a current applied to the heat source 100. The current sensor 510 may measure the current applied to the power source 250 and transmit the measured current value to the processor 610. The voltage sensor 520 may measure a voltage applied to the heat source 100. The voltage sensor 520 may check and/or measure the voltage applied to the power source 250 and transmit the measured voltage value to the processor 610. In FIG. 7, the current sensor 510 and the voltage sensor 520 are shown separately, but the current sensor 510 and the voltage sensor 520 may be implemented as a single device. The temperature sensor 530 may check and/or measure the temperature inside the cooking chamber 11 and transmit the measured temperature value to the processor 610.

In addition, the sensor 500 may include a food position sensor 540. The food position sensor 540 may identify food placed on the shelf 30. Specifically, the food position sensor 540 may identify a position of food disposed on the shelf 30. The food position sensor 540 may transmit position data of the food to the controller 600. The location data of food may include three-dimensional location data of food.

The food position sensor 540 may include an image sensor such as a camera and/or a non-image sensor such as a radar. In addition, the food position sensor 540 may include an optical device that irradiates light to food. An image sensor, such as a camera, can photograph food and acquire image data. Non-image sensors such as radar transmit radio waves to food, receive radio waves reflected from food, and acquire location data using transmitted radio waves and received radio waves.

The controller 600 may include a processor 610 and a memory 620. The processor 610 is hardware and may include a logic circuit and an operation circuit. The processor 610 may control components of the cooking apparatus 1 electrically connected by using programs, instructions, and/or data stored in the memory 620 to operate the cooking apparatus 1. The controller 600 may be implemented as a control circuit including a capacitor, a coil, and a resistance element. The processor 610 and the memory 620 may be implemented as separate chips, or may be implemented as a single chip. In addition, the controller 600 may include a plurality of processors and a plurality of memories.

The memory 620 may store programs and/or data for the operation of the cooking apparatus 1 and may store temporary data generated by the processor 610. The memory 620 includes a nonvolatile memory such as a ROM (Read Only Memory) and a flash memory for storing data for a long period of time, and a volatile memory such as static random access memory (S-RAM), D—May include a volatile memory for storing data temporarily.

The processor 610 may selectively and/or independently change an operation setting of each of the heaters 200 (210, 220, 230, 240) disposed on the cooking chamber 11. In addition, the processor 610 selectively and/or independently changes the operation settings of the heaters 210, 220, 230, 240 and the magnetron 300 that is disposed under the cooking chamber 11 to provide high frequency.

Hereinafter, the operation of the cooking apparatus 1 will be described in detail.

The controller 600 may determine at least one cooking area in which cooking is to be performed among the first cooking area 34 or the second cooking area 35 of the shelf 30 based on a user input. The controller 600 may control the display 23 to display a recipe related to the determined cooking area. In addition, the controller 600 may control the heater 200 in response to selection of a recipe.

The recipe related to the cooking area may include a name and/or a type of food that can be cooked in the cooking area. In addition, the recipe may include cooking parameters applied to food. The cooking parameter may include, for example, a cooking temperature, a heat source to be operated and/or an operation time of the heat source.

The recipe may include a main recipe and a sub recipe. The sub recipe is defined as a recipe applied to each of the first cooking area 34 and the second cooking area 35. The main recipe is a recipe for simultaneously cooking in a plurality of cooking areas 34 and 35, and may include a first sub recipe and a second sub recipe. If there are three or more cooking areas, the main recipe may contain three or more sub recipes.

When a conventional cooking apparatus wants to cook a plurality of foods at the same time, it is possible to cook only with a configuration of predetermined foods. In addition, since the conventional cooking apparatus cannot change the position where a plurality of foods are cooked in the cooking chamber, there was an inconvenience that the user must place food in a position guided by the cooking apparatus.

However, the cooking apparatus according to an embodiment may determine a cooking area in which food is placed and a recipe to be applied to the cooking area according to the intention of the user. That is, according to the cooking apparatus according to an embodiment, when a user wants to cook a plurality of foods at the same time, a user can designate a cooking area in which food is placed, and the user can select a recipe to be applied to a designated cooking area. Therefore, user convenience can be improved.

As described above, the input 21 may receive a user's input for selecting a cooking area. For example, the input 21 may receive a user's input for selecting the first cooking area 34, and may receive a user's input for selecting the second cooking area 35 after a predetermined time elapses. In other words, the selection of the first cooking area 34 and the selection of the second cooking area 35 may be made sequentially. In this case, the controller 600 may determine the first cooking area 34 and the second cooking area 35 as a cooking area in which cooking is to be performed.

When the first cooking area 34 is selected, the controller 600 may control the display 23 to display a sub recipe related to the first cooking area 34. For example, the controller 600 may control the display 23 so that names of foods that can be cooked in the first cooking area 34 are displayed as a list. When a name of a specific food is selected by a user's input, the controller 600 may control the display 23 to display cooking parameters applied to the selected food.

When the first cooking area 34 is selected and the first sub recipe related to the first cooking area 34 is selected, the controller 600 displays a list of second sub recipes applicable to the second cooking area 35 and controls the display to display the list. For example, when “beef steak” is selected as the first sub-recipe related to the first cooking area 34, “carrot, garlic, and beans” are used as the second sub-recipe applicable to the second cooking area 35. The user may select one of “carrots, garlic, beans” as the second sub recipe.

As described above, the cooking apparatus 1 according to the embodiment displays food that can be cooked in the second cooking area 35 together with the food in the first cooking area 34, the user can easily identify the composition that can be cooked simultaneously.

When a second sub-recipe applied to the second cooking area 35 is determined, the controller 600 controls the first heater 210 to provide heat to the first cooking area 34 based on the first sub recipe, and controls the second heater 220 that provides heat to the second cooking area 35 based on the second sub recipe. Therefore, foods with different cooking methods can be cooked independently in different areas.

As described above, each of the sub recipes may include cooking parameters applied to food. The first sub recipe may include operating the first heater 210 for 9 minutes as a cooking parameter applied to a beef steak. The second sub recipe may include operating the second heater 220 for 5 minutes as a cooking parameter applied to the carrot.

Meanwhile, input 21 may receive a user's input for selecting both the first cooking area 34 and the second cooking area 35. The input 21 may receive both selection of the first cooking area 34 and selection of the second cooking area 35 within a predetermined time. The predetermined time may be, for example, 1 second or 2 seconds. The predetermined time may mean a time at which it can be determined that the selection of the first cooking area 24 and the selection of the second cooking area 35 are simultaneously input.

When both the first cooking area 34 and the second cooking area 35 are selected within a predetermined time, the controller 600 may control the display 23 to display a main recipe including a first sub recipe and a second sub recipe. The main recipe may be composed of a combination of a first sub recipe and a second sub recipe. The display 23 may display a plurality of main recipes. Each main recipe may contain more than one food name and/or total cooking time. For example, the main recipe may be displayed as “Beef Steak & Carrot/Total Cooking Time 9 minutes”.

When a user's input for selecting one of the main recipes is received, the controller 600 may control the display 23 to display sub recipes included in the selected main recipe.

In this case, the controller 600 may apply one of the first sub recipe or the second sub recipe to the first cooking area 34 and the other to the second cooking area 35 based on the user's input. For example, a second sub recipe may be applied to the first cooking area 34 and a first sub recipe may be applied to the second cooking area 35. To this end, the controller 600 may control the display 23 to display an inquiry message regarding the application position of each of the first sub recipe and the second sub recipe.

In this way, the user can arbitrarily select a sub recipe to be applied to each cooking area. That is, in cooking a plurality of foods at the same time, the degree of freedom increases in selection of a cooking location and a recipe. Therefore, user convenience can be improved.

Meanwhile, the selection of the first cooking area 34 may be input, and the selection of the second cooking area 35 may not be input. In this case, the controller 600 may determine the first cooking area 34 as a cooking area in which cooking is to be performed, and may control the display 23 so that all sub recipes are displayed as recipes related to the first cooking area 34. In addition, when the recipe applied to the first cooking area 34 is determined as the first sub recipe, the controller 600 may control the first heater 210 based on the first sub recipe.

The controller 600 may determine whether food is located within the determined cooking area using data acquired by the sensor 500. Specifically, the controller 600 may determine the position of the food by using image data and/or radar data acquired by the sensor 500.

The controller 600 may control the heater 200 to provide heat to the determined cooking area when food is located within the determined cooking area. Conversely, the controller 600 may stop the operation of the heater 200 when the food is not located within the determined cooking area. Through this, it is possible to prevent a cooking failure and secure the safety of the cooking apparatus.

In addition, the controller 600 may control the display 23 to display a warning message guiding the change of the position of the food when the food is not located within the determined cooking area. Through this, a notification may be provided to the user so that food is correctly placed in the determined cooking area, and it is possible to prevent cooking failure and secure the safety of the cooking apparatus.

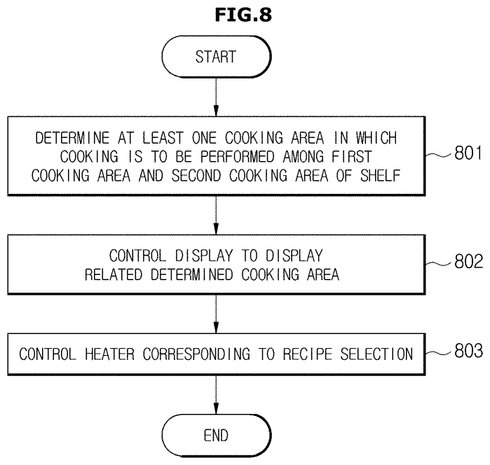

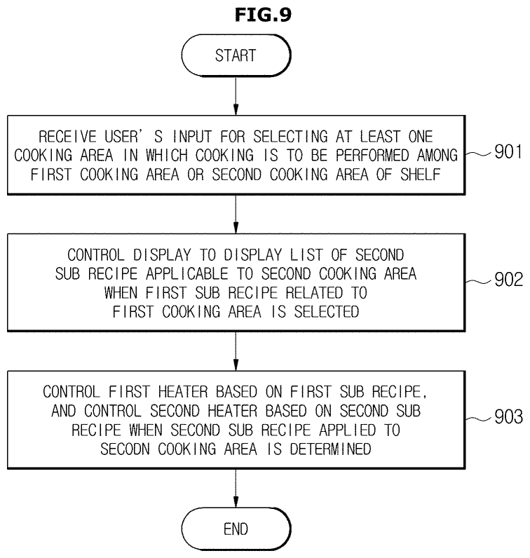

FIGS. 8, 9, 10, and 11 are flowcharts illustrating a method of controlling a cooking apparatus. FIGS. 9, 10, and 11 will be described with a more specific embodiment of the control method of the cooking apparatus described in FIG. 8.

Referring to FIG. 8, the controller 600 of the cooking apparatus 1 according to an embodiment may determine at least one cooking area in which cooking is to be performed among the first cooking area 34 or the second cooking area 35 of the shelf 30 based on user input received via input 21(801). The controller 600 may control the display 23 to display a recipe related to the determined cooking area (802). In addition, the controller 600 may control the heater 200 in response to selection of a recipe based on a user's input (803).

The cooking apparatus according to an exemplary embodiment may determine a cooking area in which food is placed and a recipe to be applied to the cooking area according to a user's intention. That is, according to the cooking apparatus according to an embodiment, when a plurality of foods are to be cooked simultaneously, the user can designate a cooking area where food is placed and select a recipe to be applied to the designated cooking area. Therefore, user convenience can be improved.

Referring to FIG. 9, the input 21 of the cooking apparatus 1 according to an embodiment may receive a user input that selecting at least one cooking area to be cooked among the first cooking area 34 or the second cooking area 35 of the shelf 30 (901). For example, input 21 may receive a user's input for selecting the first cooking area 34, and may receive a user's input for selecting the second cooking area 35 after a predetermined time elapses. In other words, the selection of the first cooking area 34 and the selection of the second cooking area 35 may be made sequentially. In this case, the controller 600 may determine the first cooking area 34 and the second cooking area 35 as a cooking area in which cooking is to be performed.

When the first cooking area 34 is selected, the controller 600 may control the display 23 to display a sub recipe related to the first cooking area 34. When the first cooking area 34 is selected, and the first sub-recipe related to the first cooking area 34 is selected, the controller 600 may control the display 23 to display a list of second sub recipes applicable to the second cooking area 35 (902). As described above, the cooking apparatus 1 according to an embodiment displays food that can be cooked in the second cooking area 35 together with the food in the first cooking area 34, so that the user can easily grasp the composition that can be cooked simultaneously.

When a second sub-recipe applied to the second cooking area 35 is determined, the controller 600 controls the first heater 210 to provide heat to the first cooking area 34 based on the first sub-recipe and controls the second heater 220 that provides heat to the second cooking area 35 based on the second sub recipe (903). Therefore, foods with different cooking methods can be cooked independently in different areas.

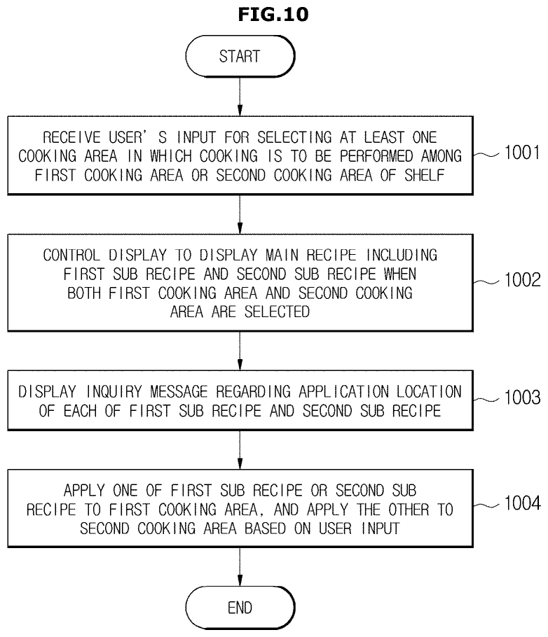

Referring to FIG. 10, input 21 of the cooking apparatus 1 according to an embodiment may receive a user input selecting at least one cooking area to be cooked among the first cooking area 34 or the second cooking area 35 of the shelf 30 (1001). For example, input 21 may receive a user's input for selecting both the first cooking area 34 and the second cooking area 35. Input 21 may receive both selection of the first cooking area 34 and selection of the second cooking area 35 within a predetermined time. The predetermined time may be, for example, 1 second or 2 seconds. The predetermined time may mean a time at which it can be determined that the selection of the first cooking area 24 and the selection of the second cooking area 35 are simultaneously input.

When both the first cooking area 34 and the second cooking area 35 are selected within a predetermined time, the controller 600 may control the display 23 to display a main recipe including a first sub recipe and a second sub recipe (1002). The controller 600 may control the display 23 to display an inquiry message regarding the application position of each of the first sub recipe and the second sub recipe (1003).

The controller 600 may apply one of the first sub recipe or the second sub recipe to the first cooking area 34 and the other to the second cooking area 35 based on a user input (1004). For example, a second sub recipe may be applied to the first cooking area 34 and a first sub recipe may be applied to the second cooking area 35. In this way, the user can arbitrarily select a sub recipe to be applied to each cooking area. That is, in cooking a plurality of foods at the same time, the degree of freedom increases in selection of a cooking location and a recipe. Therefore, user convenience can be improved.

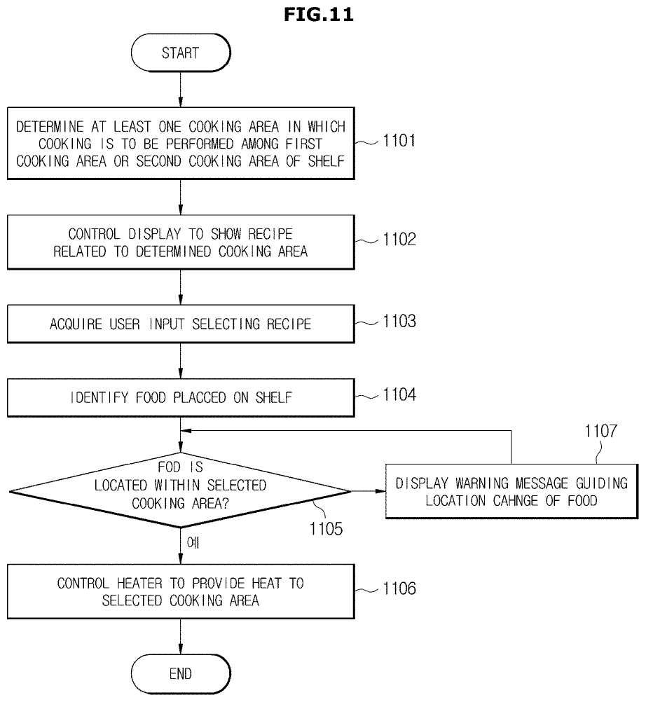

Referring to FIG. 11, the controller 600 of the cooking apparatus 1 according to an exemplary embodiment may determine at least one cooking area in which cooking is to be performed among a first cooking area 34 or a second cooking area of the shelf 30 based on a user input received through input 21 (1101). The controller 600 may control the display 23 to display a recipe related to the determined cooking area (1102).

The input 21 of the cooking apparatus 1 according to an embodiment may obtain an input of a user selecting a recipe (1103). For example, applying one of the first sub recipe or the second sub recipe to the first cooking area 34, and an input of a user applying the other to the second cooking area 35 may be transmitted to the controller 600 through input 21.

The sensor 500 of the cooking apparatus 1 according to an embodiment may identify food disposed on the shelf 30 (1104). The sensor 500 may transmit information and/or data on the identified food to the controller 600. The controller 600 may determine whether food is located within the determined cooking area using data acquired by the sensor 500 (1105). When the food is located within the determined cooking area, the controller 600 may control the heater 200 to provide heat to the determined cooking area (1106).

Conversely, when the food is not located within the determined cooking area, the controller 600 may stop the operation of the heater 200. In addition, the controller 600 may control the display 23 to display a warning message guiding the change of the position of the food when the food is not located within the determined cooking area (1107). Through this, a notification may be provided to the user so that food is correctly placed in the determined cooking area, and it is possible to prevent cooking failure and secure the safety of the cooking apparatus.

As described above, in the disclosed cooking apparatus and its control method, when a plurality of foods are cooked at the same time, a cooking area in which food is placed and a recipe to be applied to the cooking area may be determined according to a user's intention.

That is, according to the disclosed cooking apparatus and its control method, a user can designate a cooking area in which food is placed, and select a recipe to be applied to the designated cooking area. Therefore, user convenience can be improved.

Meanwhile, the disclosed embodiments may be implemented in the form of a storage medium that stores instructions executable by a computer. The instruction may be stored in the form of a program code, and when executed by a processor, a program module may be generated to perform the operation of the disclosed embodiments.

A storage medium that can be read by a device may be provided in the form of a non-transitory storage medium. Here, ‘non-transitory storage medium’ is a device that is tangible and only means that it does not contain a signal (e.g., electromagnetic wave), this term does not distinguish between a case where data is stored semi-permanently and temporarily in a storage medium. For example, the ‘non-transitory storage medium’ may include a buffer in which data is temporarily stored.

According to an embodiment, a method according to various embodiments disclosed in the present document may be provided by being included in a computer program product. The computer program products can be traded between sellers and buyers as commodities. The computer program product is distributed in the form of a device-readable storage medium (e.g. compact disc read only memory (CD-ROM)), or the computer program product may be distributed (e.g., downloaded or uploaded) online, through an application store (e.g., Play Store™) or directly between two user devices (e.g., smartphones). In the case of online distribution, at least a portion of the computer program product (e.g., downloadable app) is at least in a device-readable storage medium such as the manufacturer's server, the application store's server, or the relay server's memory, and it may be temporarily stored or created temporarily.

As described above, the disclosed embodiments have been described with reference to the accompanying drawings. Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A cooking apparatus, comprising:
a display;
an input configured to receive a user's input;
a shelf disposed inside a cooking chamber of the cooking apparatus, the shelf including a first cooking area and a second cooking area;
a heater configured to provide heat to at least one of the first cooking area and the second cooking area; and
a controller configured to:
determine at least one cooking area in which cooking is to be performed among the first cooking area and the second cooking area based on the user's input,
control the display to display at least one recipe related to the determined at least one cooking area, and
control the heater in response to a selection of the at least one recipe.

2. The cooking apparatus according to claim 1, wherein the controller is further configured to control the display to display a list of second sub recipes applicable to the second cooking area when the first cooking area is selected and a first sub recipe related to the first cooking area is selected by the user's input.

3. The cooking apparatus according to claim 2, wherein when a second sub recipe applied to the second cooking area is determined, the controller is further configured to control a first heater that provides heat to the first cooking area based on the first sub recipe, and control a second heater that provides heat to the second cooking area based on the second sub recipe.

4. The cooking apparatus according to claim 1, wherein the controller is configured to control the display to display a main recipe including a first sub recipe and a second sub recipe when both the first cooking area and the second cooking area are selected within a predetermined time by the user's input.

5. The cooking apparatus according to claim 4, wherein the controller is further configured to apply one of the first sub recipe and the second sub recipe to the first cooking area and the other of the first sub recipe and the second sub recipe to the second cooking area based on the user's input.

6. The cooking apparatus according to claim 4, wherein the controller is further configured to control the display to display an inquiry message regarding an application location of each of the first sub recipe and the second sub recipe.

7. The cooking apparatus according to claim 1 further comprising a sensor configured to identify food disposed on the shelf, and
wherein the controller is further configured to control the heater to provide heat to the determined at least one cooking area when the sensor identifies that the food is located in the determined at least one cooking area.

8. The cooking apparatus according to claim 7, wherein the controller is further configured to control the display to display a warning message guiding a change of a location of the food when the sensor identifies that the food is not located within the determined at least one cooking area.

9. A controlling method of a cooking apparatus, comprising:
determining at least one cooking area in which cooking is to be performed among a first cooking area of a shelf and a second cooking area of the shelf, the shelf disposed inside a cooking chamber of the cooking apparatus, based on a user input received through an input,
controlling a display to display at least one recipe related to the determined at least one cooking area, and
controlling a heater in response to a selection of the at least one recipe.

10. The method according to claim 9, wherein controlling the display includes controlling the display to display a list of second sub recipes applicable to the second cooking area when the first cooking area is selected and a first sub recipe related to the first cooking area is selected by the user's input.

11. The method according to claim 10, wherein controlling the heater includes when a second sub recipe applied to the second cooking area is determined, controlling a first heater that provides heat to the first cooking area based on the first sub recipe, and controlling a second heater that provides heat to the second cooking area based on the second sub recipe.

12. The method according to claim 9, wherein controlling the display includes controlling the display to display a main recipe including a first sub recipe and a second sub recipe when both the first cooking area and the second cooking area are selected within a predetermined time by the user's input.

13. The method according to claim 12 further comprising: applying one of the first sub recipe and the second sub recipe to the first cooking area and the other of the first sub recipe and the second sub recipe to the second cooking area based on the user's input.

14. The method according to claim 12, controlling the display further includes controlling the display to display an inquiry message regarding an application location of each of the first sub recipe and the second sub recipe.

15. The method according to claim 9 further comprising identifying food disposed on the shelf by a sensor, and
wherein controlling the heater includes controlling the heater to provide heat to the determined at least one cooking area when the sensor identifies that the food is located in the determined at least one cooking area.

16. The method according to claim 15, wherein controlling the display further includes displaying a warning message guiding a change of a location of the food when the sensor identifies that the food is not located within the determined at least one cooking area.
